(19) United States
(12) Patent Application Publication
(10) Pub. No.: US 2003/0236681 A1
(43) Pub. Date: Dec. 25, 2003

(54) Medicine prescription apparatus

(75) Inventors: Satoshi Ninomiya, Kawasaki (JP); Hirokatsu Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/291,438

(22) Filed: Nov. 12, 2002

(30) Foreign Application Priority Data
Jun. 24, 2002 (JP) 2002-182337

(51) Int. Cl. G06F 17/60

(52) U.S. Cl. 705/2

(57) ABSTRACT

The prescription method without checking some points such as a term of validity may result in an excess of prescription. Furthermore, the patient may subsequently take an excessive amount of the prescribed medicine because the patient takes the prescribed medicine under his self-control. Consequently, in the case that a medicine is prescribed for the patient through networks without a medical examination for the patient, it is necessary to have the patient take the prescribed medicine appropriately. Even with respect to a habitual medicine that has been taken for a long time, it is necessary to prescribe a medicine permitted by a doctor at the time instructed by the doctor. A method for prescribing medicine securely is pursued so that a patient can take the medicine appropriately.

### BACKGROUND OF THE INVENTION

1. Field of the Invention

The present invention relates to medicine prescription apparatuses, more particularly, to a medicine prescription apparatus for a patient taking particular medicines continuously.

2. Description of the Related Art

Regarding medicines prescribed for a patient by a medical institution such as a hospital, a usual procedure is as follows: a doctor first issues a prescription for the patient, and then the patient brings the issued prescription to a pharmacy and receives prescribed medicines. Consequently, the patient needs to visit the medical institution and have the doctor issue the prescription in order to receive the prescribed medicines.

However, even in the case that a patient has a chronic disease without a specific symptom and needs to continue on taking a medicine for preventive measures, the patient needs to visit a medical institution, follow the above-mentioned procedure and obtain the medicine each time before the previously prescribed medicine runs out. That imposes burdens of time and body on the patient.

On the other hand, the recent spread of the Internet has urged developments of prescription methods designed to decrease the burdens of time and body on the patient by transferring prescription information between a medical institution and a pharmacy through networks.

Regarding conventional prescription methods as mentioned above, an example is disclosed in Japanese Laid-Open Patent Application No. 2001-357127.

According to the above-mentioned example, through the Internet, a patient requests an issue of a prescription from a hospital and then the prescription information is sent from the hospital to a pharmacy in order to decrease the patient's loss caused by visiting the hospital.

Under the heretofore-described conventional prescription methods, there is a possibility that when a patient requests a prescription, the requested prescription is provided to the patient without checking whether or not it is appropriate to respond to the patient's request at the time.

However, prescription methods without a term check on validity of the prescription concerned may result in some problems. For example, in the case that a patient takes hypnotics continuously for a mental disease, the term check-free prescription methods may cause serious trouble such as an excess of prescription, because the patient takes the prescribed medicine under the patient's own control. Consequently, in the case that a medicine is allowed to be prescribed through networks without a medical examination, it is necessary to successfully manage medicines to be prescribed. Even with respect to habitual medicines that have been taken for a long time, the patient is required to receive prescribed medicines in accordance with doctor's instruction including a term in which the patient should take the medicines. As a result, a method for prescribing medicines through networks securely is pursued so that a patient can take the medicines appropriately.

### SUMMARY OF THE INVENTION

It is a general object of the present invention to provide a medicine prescription apparatus that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by an apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, a medicine prescription apparatus according to the present invention comprises a registration part registering prescription information on a patient and an effective term of the prescription information; a receiving part receiving a prescription request for the prescription information from a predetermined terminal; a determination part checking whether or not the present date is within the effective term of the prescription information; and a sending part sending the prescription information to the predetermined terminal if the determination part determines that the present date is within the effective term of the prescription information.

According to the present invention, the above-mentioned medicine prescription apparatus implements these four parts by using networks connecting between terminals of medical institutions and patients. As a result, a patient does not have to visit a hospital periodically to undergo a medical examination so as to receive medicines due to the transferring of information between medical institutions and patients through the networks. In addition, the patient can receive prescribed medicines at an arbitrary pharmacy as long as the pharmacy is registered. Accordingly, it is possible that the patient can have some burdens decreased thereof: transportation expenses to the hospital, traveling time to the hospital, and waiting time at the hospital.

Furthermore, according to the present invention, the registration part prompts a doctor to input not only prescription information on the patient but also a prescription condition such as a term in which the patient should take prescribed medicines. When the receiving part receives a prescription request from the patient, the determination part determines whether or not the request is appropriate at the time on the basis of the prescription information and the prescription condition registered under the registration part. Unless the request is appropriate, the patient is not allowed to receive the prescribed medicines.

Accordingly, the medicine prescription apparatus prevents the patient from receiving any prescribed medicine outside of a valid term regarding the prescription information and the corresponding prescription condition that a doctor in charge is required to set for the patient, thereby avoiding administering excessive amounts of medicines and offering the medicines to the patient securely. Depending upon a type of disease and prescribed medicines, the medicine prescription apparatus is additionally used for a doctor to set up the number of times within which the patient is allowed to receive prescribed medicines according to the patient's request even if the patient does not undergo a medical examination.

Thus, according to the present invention, it becomes possible not only to decrease the burdens on the patient but also to provide prescribed medicines with the patient properly.

### BRIEF DESCRIPTION OF THE DRAWINGS

FIG. 1 is a diagram roughly illustrating a system of a first embodiment of the present invention;

FIG. 2 is a diagram roughly illustrating a process in the present invention;

FIG. 3 is a diagram illustrating examples of a patient file, a pharmacy file and a prescription condition table;

FIG. 4 is a diagram illustrating examples of a prescription management file and a medicine information file;

FIG. 5 is a flowchart of a main process;

FIG. 6 is a flowchart of a prescription information registration process;

FIG. 7 is a flowchart of a prescription display process;

FIG. 8 is a flowchart of a display information determination process;

FIG. 9 is a flowchart of a prescription effective term check process;

FIG. 10 is a flowchart of a limited time of prescriptions check process;

FIG. 11 is a flowchart of a display process;

FIG. 12 is a flowchart of a prescription information release process;

FIG. 13 is a flowchart of a prescription process;

FIG. 14 is a flowchart of a prescription completion process;

FIG. 15 is a diagram illustrating an example of a prescription information registration screen;

FIG. 16 is a diagram illustrating an example of a prescription display screen;

FIG. 17 is a flowchart of a prescription display process in a second embodiment of the present invention;

FIG. 18 is a diagram illustrating an example of a pharmacy selection screen;

FIG. 19 is a diagram roughly illustrating a process in a third embodiment of the present invention;

FIG. 20 is a flowchart of a main process in the third embodiment of the present invention;

FIG. 21 is a flowchart of a prescription display process in the third embodiment of the present invention;

FIG. 22 is a flowchart of a display process in the third embodiment of the present invention;

FIG. 23 is a diagram illustrating an example of a prescription display screen in the third embodiment of the present invention; and

FIG. 24 is a block diagram of a hardware configuration in an example of the medicine prescription apparatus according to the present invention.

### DETAILED DESCRIPTION OF THE PREFERRED EMBODIMENTS

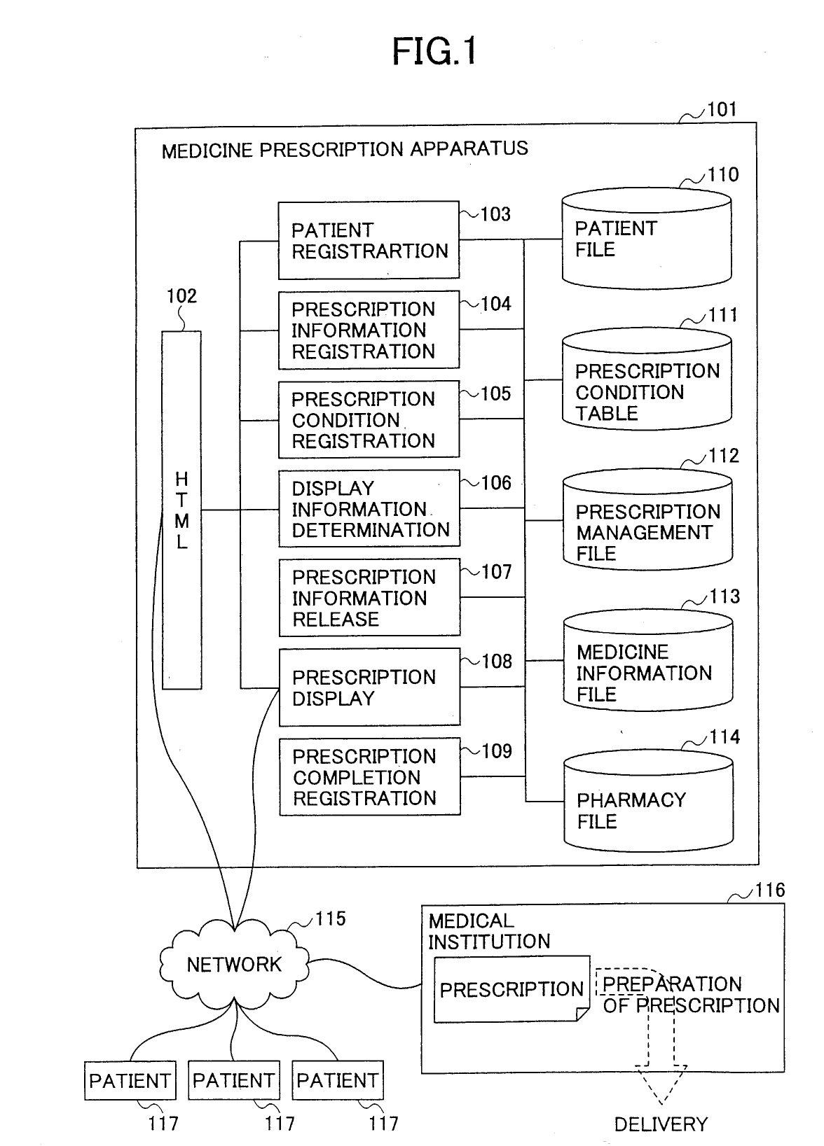

A description will now be given, with reference to FIG. 1, of an outline of a first embodiment of the present invention. In FIG. 1, a medicine prescription apparatus 101 works for prescribing medicines for patients 117. The medicine prescription apparatus 101 is located inside a facility of a medical institution 116 such as a hospital and a pharmacy, or is placed in a location different from the facility of the medical institution 116.

An external storage in the medical prescription apparatus contains a patient file 110 for storing fundamental information on the patients 117, a prescription condition table 111 for storing prescription conditions on each prescription for an individual patient, a prescription management file 112 for storing management information on each prescription for an individual patient, a medicine information file 113 for storing information on medicines to be prescribed, and a pharmacy file 114 for storing information on pharmacies preparing prescriptions. Furthermore, the patient file 110 contains a patient information registration program 103 for registering the fundamental information on the patients. The prescription management file 112 and the medicine information file 113 contain a prescription information registration program 104 for registering prescription information. The prescription condition table 111 contains a prescription condition registration program 105 for registering a condition on prescription information, a display information determination program 106 for determining prescription information to be displayed on the patient's terminal, a prescription information release program 107 for releasing prescription information corresponding to a prescription requested by the patient 117 to the medical institution 116, a prescription display program 108 for displaying prescription information, and a prescription completion registration program 109 for registering completion of preparing a prescription and of delivering prescribed medicines to the patient 117.

As mentioned above, these programs are stored in the external storage in the medicine prescription apparatus 101. At execution, each of the programs is read into an internal memory of the medicine prescription apparatus 101. Then, if necessary, the patient file 110, the prescription condition table 111, the prescription management file 112, the medicine information file 113 and the pharmacy file 114 are referred to and updated.

Also, the external storage contains an HTML (Hyper Text Markup Language) editor 102 so that the patient 117 and the medical institution 116 can refer to and register prescription information through a network 115 in HTML form.

Here, the medicine prescription apparatus 101, the medical institution 116 and terminals of the patients 117 are connected each other through the network 115.

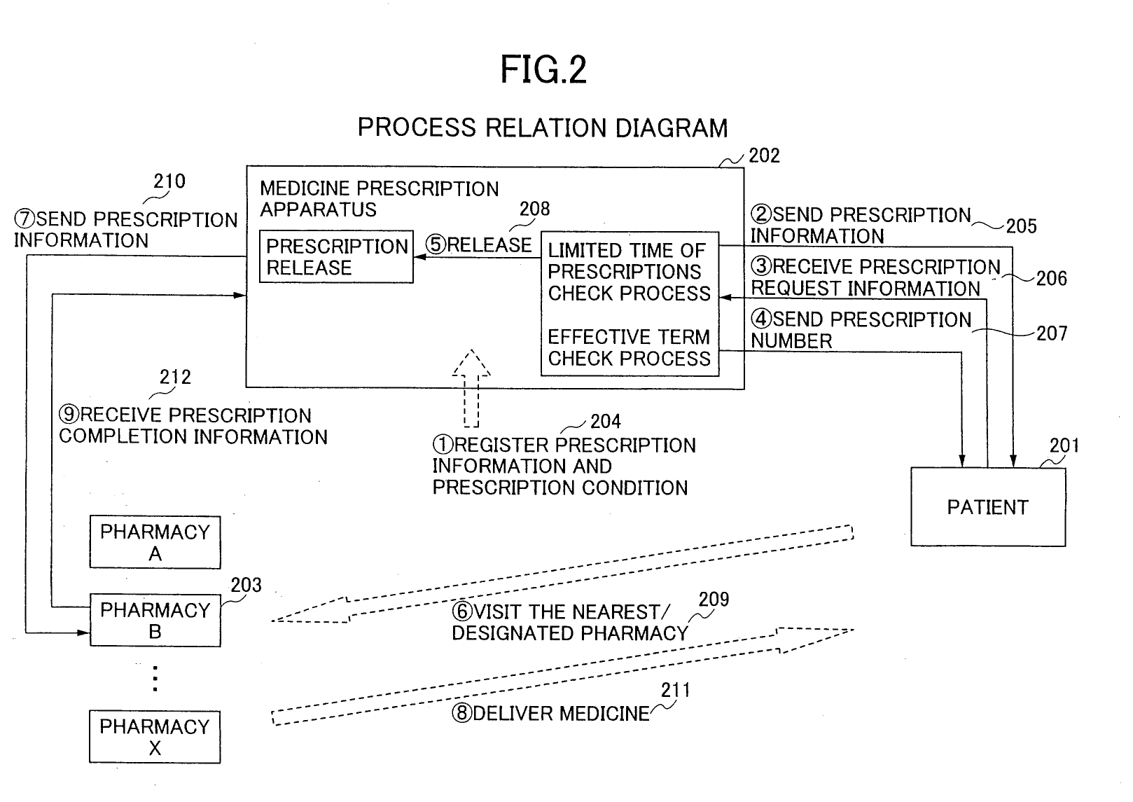

Based on the system outline as mentioned with reference to FIG. 1, a description will now be given, with reference to FIG. 2, of relationships among processes of the first embodiment of the present invention.

A doctor inputs prescription information for a patient 201 and a prescription condition thereof from a terminal (204).

For example, assume that the patient 201, who periodically visits the doctor and habitually takes preventive medicines and the like, comes to consult the doctor. Then, if the doctor permits prescribing medicines for the patient 201 even without the doctor's consultation at the next time, the doctor inputs prescription information for the patient and a prescription condition pertaining to the prescription information.

When the remainder of the medicines prescribed at the immediately previous visit is diminished, the patient has access from the patient's terminal to a medicine prescription apparatus 202 so as to request the same medicines as the previously prescribed medicines. Then, the medicine prescription apparatus 202 sends prescription information on the patient 201 to the patient's terminal (205).

At this time, the medicine prescription apparatus 202 checks prescription information to be delivered to the patient's terminal with reference to the corresponding prescription condition set by the doctor and sends only necessary prescription information in order to avoid excessive prescription.

From the prescription information received at and displayed on the patient's terminal, the patient 201 selects pieces of the prescription information that the patient would like to request, which are subsequently sent to the medicine prescription apparatus 202.

After receiving the requested pieces of prescription information from the patient's terminal (206), the medicine prescription apparatus 202 not only sends prescription numbers assigned to the requested pieces of prescription information to the patient's terminal (207), but also executes a release process to pharmacies for the requested pieces of prescription information (208).

The prescription number is uniquely assigned to an individual piece of prescription information, and identifies the prescription information.

When the prescription request is completed, the patient 201 visits the nearest pharmacy 203 and presents the prescription number sent by the medicine prescription apparatus 202 together with identification such as the patient's consultation card (209).

If a pharmacist in the pharmacy 203 is presented the prescription number together with identification, the pharmacist inputs the prescription number together with a patient number assigned to the patient on a terminal and receives the corresponding prescription information from the medicine prescription apparatus 202 (210).

Based on the received prescription information, the pharmacist prepares the prescription and delivers prescribed medicines to the patient 201 (211).

When the delivery of the medicines to the patient 201 is completed, the pharmacist sends prescription completion information to the medicine prescription apparatus 202 from the pharmacist's terminal (212).

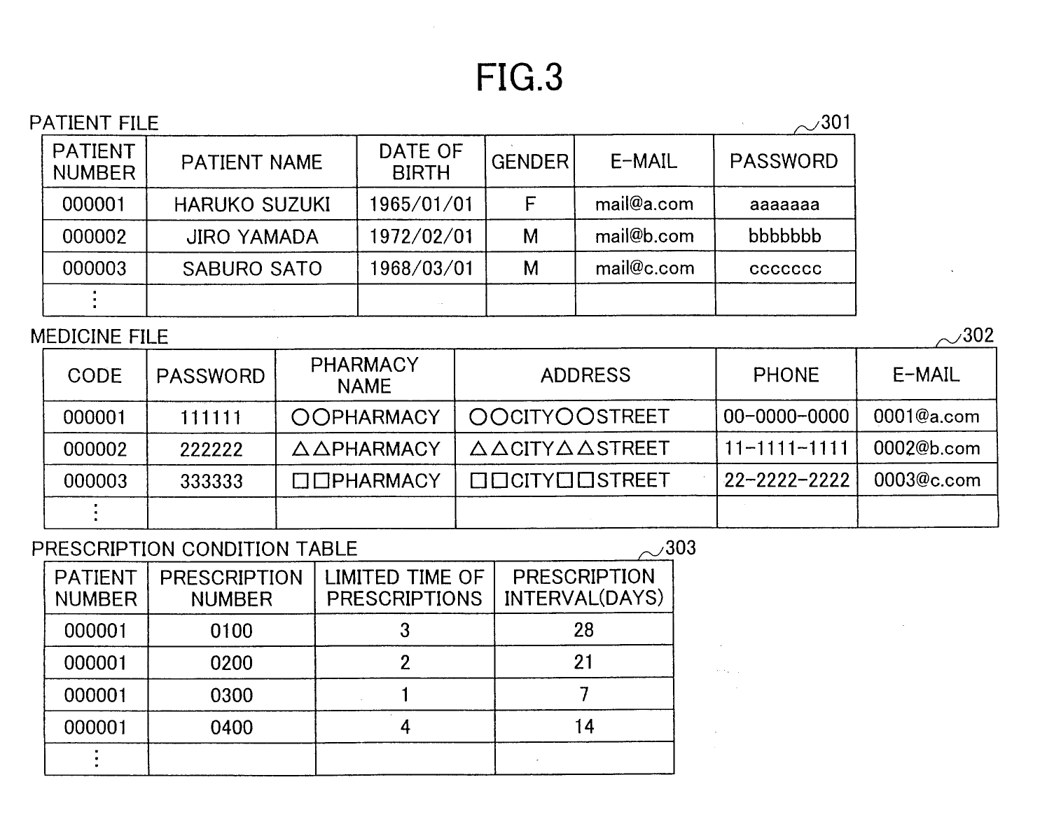

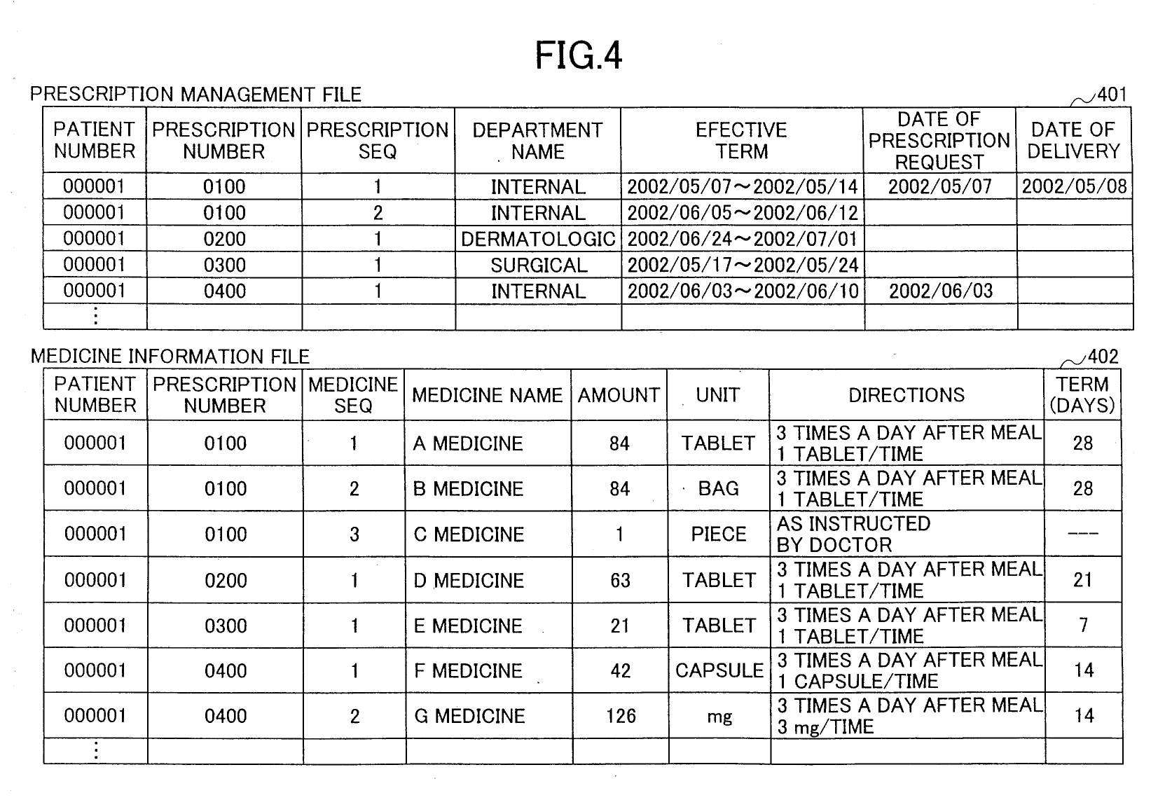

Based on the process outline as described with reference to FIG. 2, a description will now be given, with reference to FIG. 3 and FIG. 4, of a file structure of the first embodiment of the present invention.

File structures shown in FIG. 3 are involved in a patient file 301 for storing fundamental information on patients, a pharmacy file 302 for storing information on pharmacies for preparing prescriptions, and a prescription condition table 303 for storing prescription conditions on each piece of prescription information for an individual patient.

The patient file 301 maintains patient numbers, patient names, patient birthdays, patient genders, patient e-mail addresses and patient passwords. The patient password is authentication information required at the time when a patient has access from a terminal to the medicine prescription apparatus. For example, the authentication information for access comprises a patient number and a password of the patient.

The pharmacy file 302 maintains pharmacy codes for identifying each pharmacy, pharmacy passwords, pharmacy names, pharmacy addresses, pharmacy telephone numbers, and pharmacy e-mail addresses.

The pharmacy password is authentication information required at the time when a pharmacist has access from a terminal to the medicine prescription apparatus. For example, the authentication information for access comprises a pharmacy code and a password of the pharmacy.

The prescription condition table 303 maintains the patient numbers, prescription numbers, limited times of prescriptions representing that the prescription is allowed to be prepared at most the indicated number of times, and prescription intervals necessary for prescriptions.

File structures shown in FIG. 4 are involved in a prescription management file 401 for storing management information on each prescription for an individual patient and a medicine information file 402 for storing medicine information on medicines to be prescribed.

The prescription management file 401 maintains the patient numbers, the prescription numbers, prescription sequence numbers which are referred to if a plurality of prescriptions under identical prescription information are prepared, names of departments in charge, effective terms of prescription information, dates of prescription requests representing the days when patients have requested a prescription, and dates of prescriptions representing the days when patients have received prescribed medicines.

The medicine information file 402 maintains the patient numbers, the prescription numbers, medicine sequence numbers which are referred to if there are a plurality of medicines offered under identical prescription information, medicine names, amounts of prescribed medicines, units of the prescribed medicines, directions for the use of prescribed medicines, and numbers of days during which patients should take prescribed medicines.

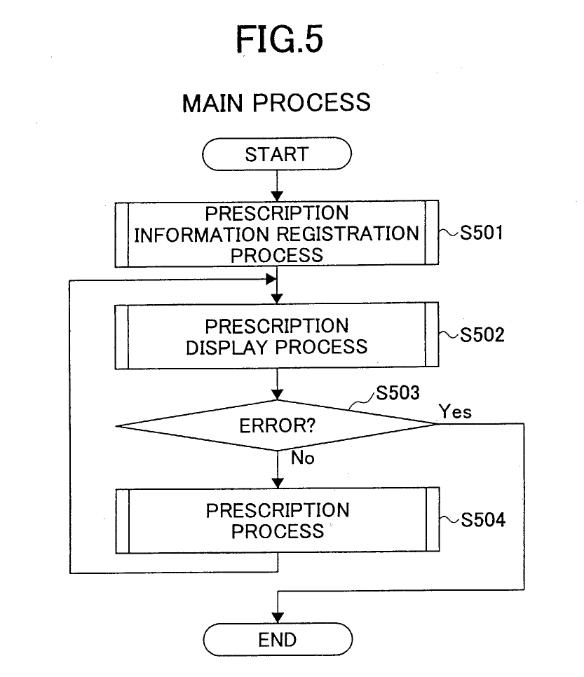

A description will now be given, with reference to a flowchart in FIG. 5, of a main process of the first embodiment of the present invention.

A doctor belonging to a medical institution registers both prescription information prescribed for a patient of the doctor and prescription conditions thereof at a prescription information registration process S501.

Then, when the remainder of medicines prescribed at the doctor's previous consultation is diminished, the patient requests the same medicines as the medicines prescribed at the previous time at a prescription display process S502.

After the prescription display process S502 is executed, it is determined whether or not the request includes an error (S503). If the request includes the error, the main process is terminated without proceeding to subsequent steps. If not, the medicine prescription apparatus moves to a prescription process S504.

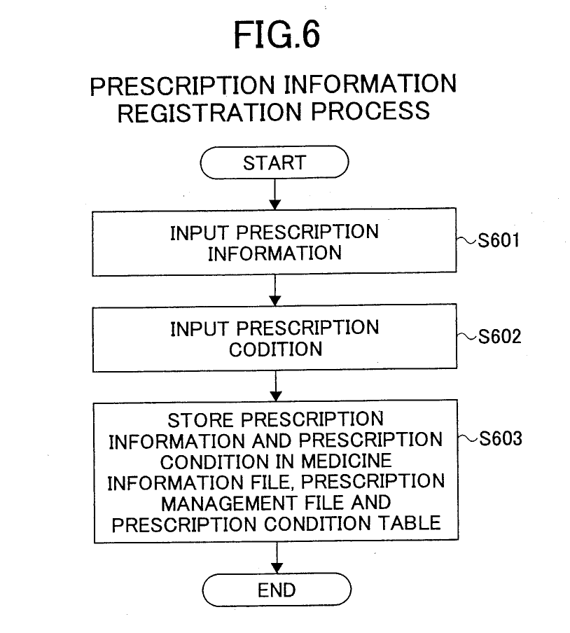

A detailed description will now be given, with reference to a flowchart in FIG. 6, of a prescription information registration process shown in the step S501 on FIG. 5.

A doctor inputs prescription information on medicines prescribed for a patient in a terminal connected with the medicine prescription apparatus through networks (S601).

The prescription information, which is involved with information on prescription management and information on prescribed medicines, mainly contains each item of the medicine information file 402 as shown on FIG. 4, namely, a medicine name, an amount of a prescribed medicine, a unit of the prescribed medicine, directions for the use of the prescribed medicine, and the number of days during which a patient should take the prescribed medicine.

Here, the prescription number and the medicine sequence number are automatically numbered according to a consecutive numbering system.

Next, the doctor sets a prescription condition on the prescription information (S602).

The prescription condition, which is a condition accompanying the prescription information, contains items of the prescription condition table 303 shown in FIG. 3, namely, a limited time of prescriptions and a prescription interval, and an item shown in FIG. 4, namely, an effective term of the prescription information.

Here, a department name in the prescription management file 401 is set according to an initial setting of a terminal, and the prescription number and the prescription sequence number are automatically numbered according to a consecutive numbering system.

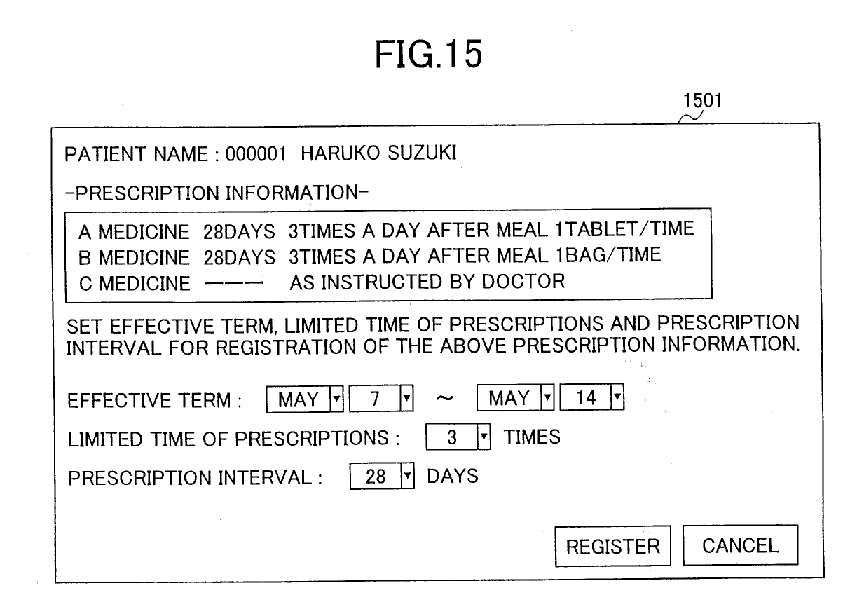

A screen 1501 in FIG. 15 is an example of a prescription condition registration screen wherein a prescription condition on prescription information input at step S601 in FIG. 6 is set.

Here, the medicine prescription apparatus may convert data into the HTML form and display the prescription condition registration screen in the HTML form on the terminal.

After the prescription information and the prescription condition are input, for example, a “REGISTER” button on the prescription condition registration screen shown in screen 1501 in FIG. 15 is pushed. Then, both the prescription information which has been input at step S601 in FIG. 6 and the prescription condition which has been set at step S602 in FIG. 6 are stored into the medicine information file 402 shown in FIG. 4, the prescription management file 401 shown in FIG. 4, and the prescription condition table 303 shown in FIG. 3 (S603).

Here, when the prescription information and the prescription condition are input, it is desirable to prepare an input screen serving for inputting the prescription information and the prescription condition. Furthermore, it is desirable that an ordering system for inputting the content of consultation or a consultation aided system such as an electronic medical record system be introduced whereby the doctor can refer to or copy a history of past prescriptions at the registration.

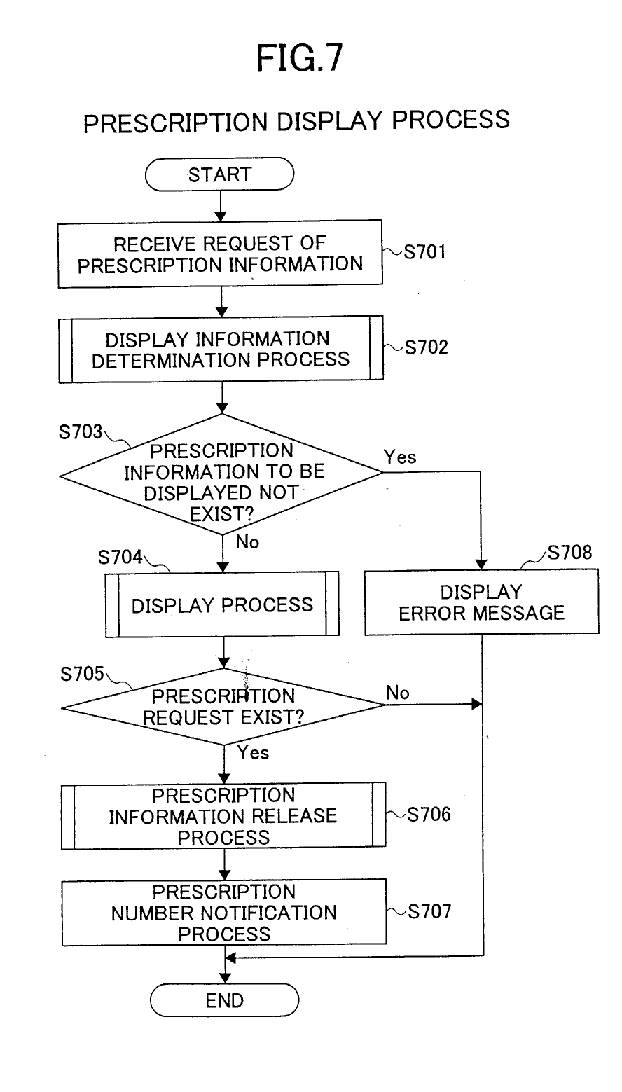

A detailed description will now be given, with reference to a flowchart in FIG. 7, of the prescription display process shown in step S502 on FIG. 5.

At the beginning, in order to request a prescription, a patient requests the medicine prescription apparatus to display the prescription information on the patient on the patient's terminal.

The medicine prescription apparatus receives the request of the prescription information from the patient's terminal through networks (S701).

After the medicine prescription apparatus receives the request from the patient's terminal, the medicine prescription apparatus executes a display information determination process S702 to check the prescription information on the patient.

The display information determination process S702 is executed, and if the display information determination process S702 determines that the prescription information concerned is not maintained, the display information determination process S702 displays on the patient's terminal a message that there is no prescription information to be displayed (S708) and stops subsequent processes.

If the display information determination process S702 determines that the prescription information concerned is maintained, the display information determination process S702 edits the prescription information according to a prescription condition and an effective term regarding the prescription information in order to display the prescription information on the patient's screen. Then, the medicine prescription apparatus sends the edited prescription information to the patient's terminal, and subsequently moves to a display process S704 to display a prescription display screen in the patient's terminal.

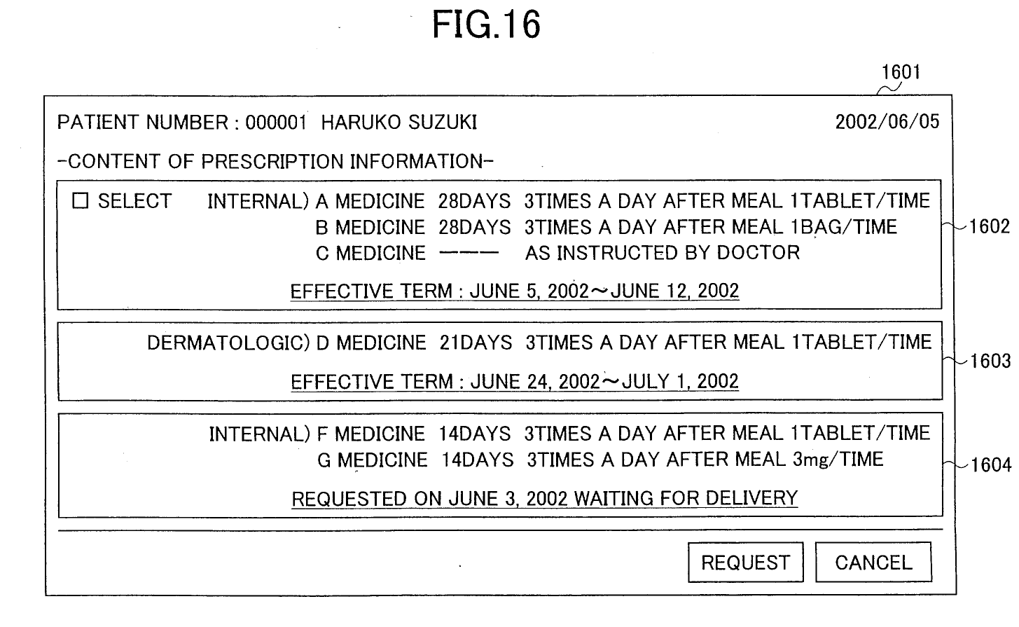

A screen 1601 shown in FIG. 16 is an example of the prescription display screen displayed on the patient's terminal as a result of the display process S704.

A detailed description will now be given, with reference to the screen 1601 in FIG. 16, of the prescription display screen.

In the prescription display screen 1601 in FIG. 16, prescription information on “Haruko Suzuki” with a patient number 000001 is displayed. Here, the present date is displayed at the upper-right on the screen. Three pieces of prescription information 1602, 1603 and 1604 are displayed in the prescription display screen.

Each of the three pieces of prescription information is displayed in a unit registered by a doctor, namely, a prescription unit.

Regarding each piece of the prescription information, a department examining the patient, prescribed medicines, numbers of days during which the medicines should be taken, and directions for the use of the medicines are displayed on the screen. Furthermore, an effective term of the prescription information is displayed at the lowest position on the screen.

The effective term means a term within which the corresponding medicines are allowed to be prescribed under the prescription information. If the day on which the patient requests a prescription is not within an effective term of the corresponding prescription information, the prescription is not allowed to be prepared.

Also, the prescription display screen 1601 has a check box and a tag “SELECT” at the most left of the prescription information 1602 displayed at the top of the three pieces of prescription information. The check box and the tag mean that the patient is allowed to select the prescription information, that is, the patient can request the prescription.

Since the present date Jun. 6, 2002 is within the effective term of the prescription information 1602, the check box and the tag “SELECT” are displayed at the left of the prescription information 1602 and the patient is allowed to request a prescription under the prescription information 1602.

Regarding the prescription information 1603, the check box and the tag “SELECT” are not displayed and the patient is not allowed to request a prescription, because the starting date of the effective term of the prescription information 1603 is Jun. 24, 2002.

Regarding the prescription information 1604, the screen represents the fact that the patient has already requested a prescription under the prescription information 1604 on Jun. 3, 2002 and prescribed medicines are now waiting for delivery to the patient.

A detailed description of how to display prescription information will be given together with descriptions of the display information determination process S702 and the display process S704 that will be mentioned later.

For example, when a list of pieces of prescription information shown in the prescription display screen 1601 on FIG. 16 is displayed, the patient determines whether to select and request a piece of prescription information that the patient would like to request among pieces of prescription information available or to request no prescription (S705)

When the patient sends a prescription request, the medicine prescription apparatus executes a prescription information release process S706 for releasing the requested prescription information to a pharmacy.

After the prescription information release process S706 is executed, the medicine prescription apparatus picks out a prescription number assigned to the prescription information processed by the prescription information release process S706 from the prescription management file 401. Then, the medicine prescription apparatus either sends the prescription number to the patient's terminal and displays the prescription number on the screen or executes a prescription number notification process S707 for delivering the prescription number to the patient's e-mail address stored in the patient file 301 through networks.

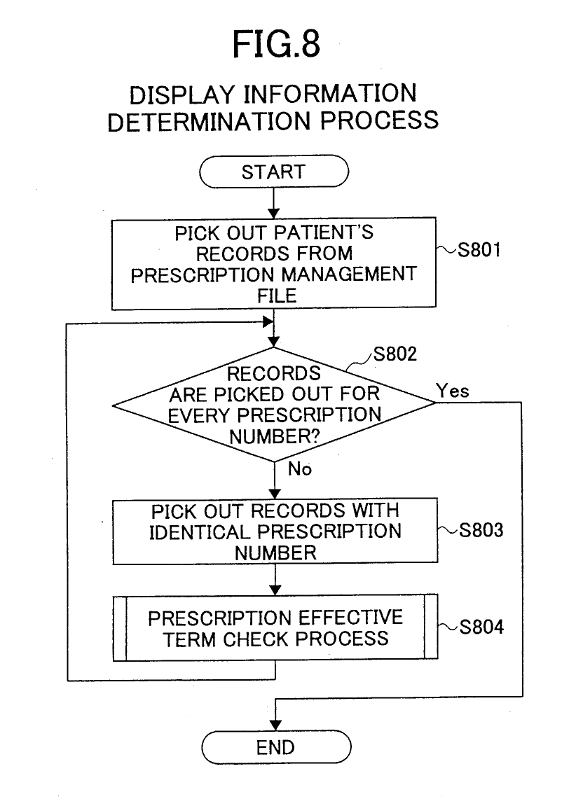

A detailed description will be now given, with reference to flowcharts in FIG. 8 through 10, of the display information determination process shown in step S702 on FIG. 7.

When the medicine prescription apparatus receives a request of prescription information from the patient's terminal, the medicine prescription apparatus picks out prescription management records on the patient concerned from the prescription management file 401 (S801).

Next, among prescription management records on the patient picked out at the step S801, the medicine prescription apparatus picks out prescription management records with an identical prescription number (S803).

Here, a supplementary explanation will be now given, with reference to an example of prescription management file shown in 401 in FIG. 4, of an execution at step S803.

The records picked out at step S801 contain the first and the second records from the top of the prescription management records shown in the 401 on FIG. 4, the third record from the top, or the fourth record from the top, whose prescription numbers are identical.

The prescription management file 401 contains two records with a patient number “000001” and a prescription number “0100” whose prescription sequence numbers are different from each other. That means that a plurality of identical prescriptions under prescription information with the prescription number “0100” have been prepared on different occasions.

A record with the prescription number “0100” and the prescription sequence number “1” represents the fact that the corresponding prescription request was received from the patient on May 7, 2002 and the delivery of prescribed medicines was completed on May 8, 2002, because the record has a date of prescription request “2002/05/07” and a date of delivery “2002/05/08”. A record with the prescription number “0100” and the prescription sequence number “2” represents the fact that the corresponding prescription request has not been received yet and therefore the prescription has not been prepared, because the record has initial values regarding both of the items, the date of prescription request and the date of delivery.

Next, after picking out prescription management records by the prescription number at step S803, that is, the two records with the patient number “000001” and the prescription number “0100” shown in the table 401 on FIG. 4, the medicine prescription apparatus executes a prescription effective term check process S804.

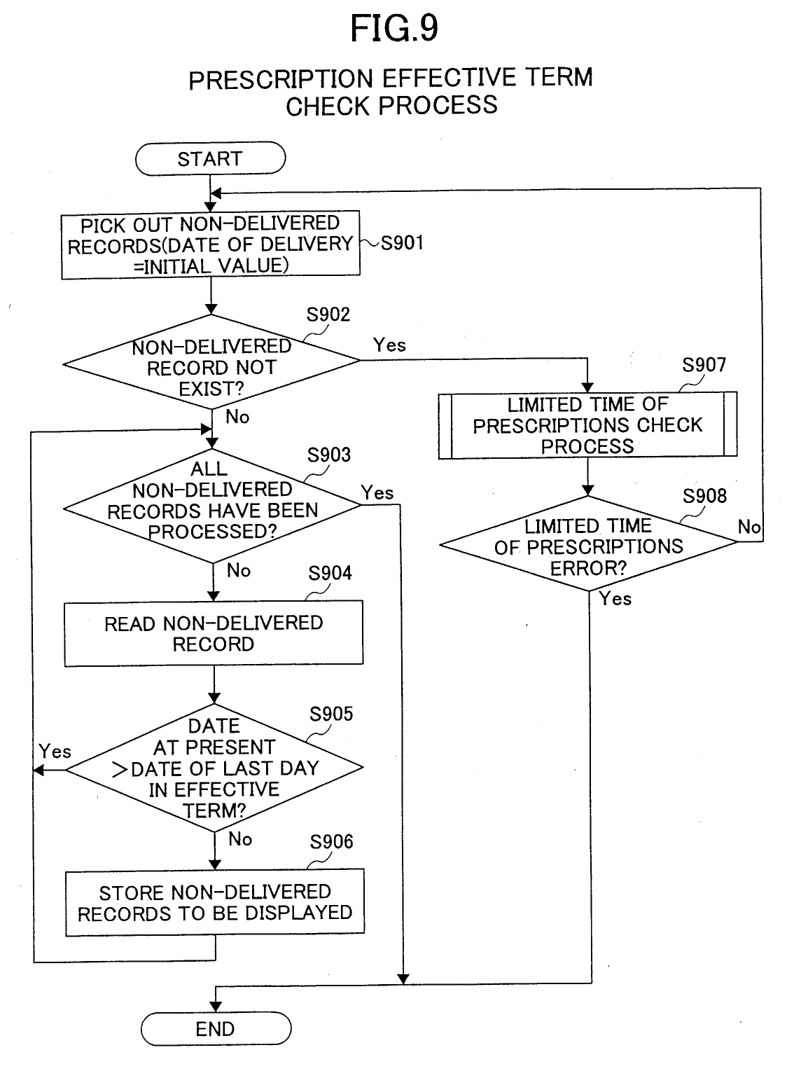

In the prescription effective term check process shown on a flowchart in FIG. 9, the medicine prescription apparatus refers to the date of delivery implying whether or not medicines have already been prescribed and delivered to the patient. Then, for each of the prescription management records picked out at the previous step, the medicine prescription apparatus picks out records such that the corresponding prescription has not been prepared yet, namely, records whose value of the date of delivery has an initial value. (S901).

In the table 401 in FIG. 4, the record with the prescription number “0100” and the prescription sequence number “2” is picked out.

A detailed description will be given in a prescription completion process which will be mentioned later, of how to update the date of prescription in the prescription management file.

After executing S901 to pick out records such that the corresponding prescription has not been prepared yet, the medicine prescription apparatus determines whether or not there is a non-delivered prescription management record (S902). If so, the medicine prescription apparatus reads the record picked out at step S902 (S904). If not, the medicine prescription apparatus moves to a limited time of prescriptions check process S907.

If there are some non-delivered records, the medicine prescription apparatus refers to effective terms of the non-delivered records and makes comparisons between the present date and a date of the ending day of the effective terms (S905). If the date of the ending day of the effective terms is before the present date, that is, the effective term is over, the medicine prescription apparatus returns to step S903 without executing subsequent processes.

At step S905, if the date of the ending day of the effective term is not before the present date, that is, the present date is within the effective term or the effective term comes hereafter, the medicine prescription apparatus stores the non-delivered records maintained in the prescription management file (S906), because the records should be displayed. Then, the medicine prescription apparatus returns to step S903.

Consequently, the record with the prescription number “0100” and the prescription sequence number “2” shown on 401 in FIG. 4 is stored.

At step S903, it is determined whether or not all of the non-delivered records picked out at the previous step have been processed. If some of the non-delivered records have not been processed, steps S904 through S906 are repeated until all of the non-delivered records are processed. If the processes are completed for any of the remaining non-delivered records, subsequent processes are finished.

Next, a description will be given of the case that there is no non-delivered record.

In the case that the medicine prescription apparatus does not have any non-delivered record, that is, the case that there is no prescription information such that the delivery of medicines to the patient is not completed at present, the medicine prescription apparatus executes the limited time of prescriptions check process S907 to check how many times the medicines have been prescribed under the prescription information concerned and then determines whether or not a prescription is allowed to be currently prepared.

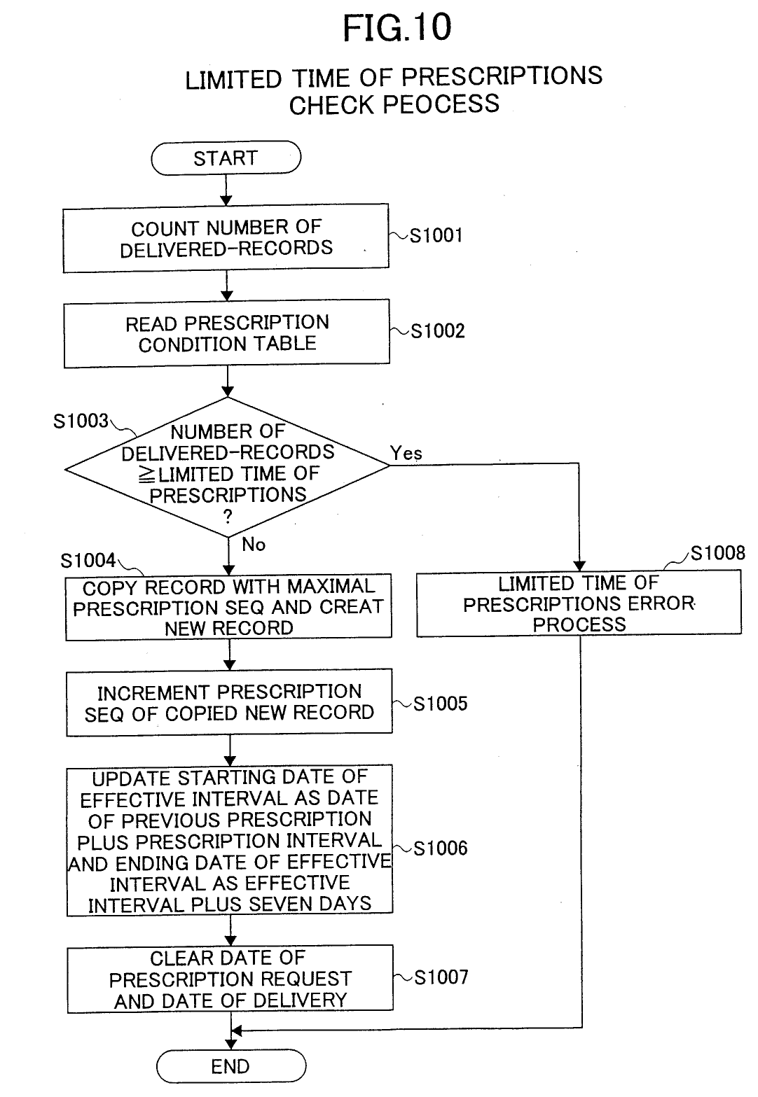

In the limited time of prescriptions check process S907 shown on a flowchart in FIG. 10, the number of delivered records with an identical prescription number picked out at step S901 in FIG. 9 is counted (S1001).

Here, the prescription management file 401 is constructed under the policy that one prescription has one record.

Consequently, the number of the records with an identical prescription number is equal to the number of prescriptions prepared under the prescription information with the prescription number concerned.

Next, the prescription condition table 303 is referred to (S1002). Then, a limited time of prescriptions of the prescription condition with the prescription number concerned is compared with the number of delivered records counted at step S1001 (S1003).

If the number of delivered records counted at step S1001 is more than or equal to the limited time of prescriptions, that is, the number of prepared prescriptions has already reached the limited time of prescriptions, the medicine prescription apparatus moves to a limited time of prescriptions error S1008 and stops subsequent processes.

If the number of the delivered records counted at step S1001 is less than the limited time of prescriptions, that is, the number of prepared prescriptions has not reached the limited time of prescriptions yet, a record with a maximal prescription sequence number, that is, the record of the latest prepared prescription is copied so as to create a new record (S1004), and then the prescription sequence number of the copied prescription record is incremented (S1005).

The copied new prescription record now maintains a date of delivery filled in the record of the prescription prepared at the latest, that is, a date of delivery of the original record. As to a starting date of a new effective term to be filled in the copied new prescription record, the starting date is given by adding the date of delivery concerned to the number of days corresponding to the prescription interval of the prescription information with the prescription number concerned for the patient in the prescription condition table 303. As to an ending date of a new effective term to be filled in the copied prescription record, the ending date is given by adding the resulting starting date computed above to the number of days corresponding to the prescription interval concerned, for example, seven days. Regarding the effective term, the copied new record is updated as the starting date and the ending date according to the above computation (S1006).

Here, when the update of the effective term is completed (S1006), a date of prescription request and a date of delivery in the copied new record, wherein values of their original record are now maintained, are cleared (S1007).

After the limited time of prescriptions check process in FIG. 10 is executed, the medicine prescription apparatus returns to step S907 in FIG. 9. Then, it is determined at step S908 whether or not the limited time of prescriptions error occurs. If the limited time of prescriptions error occurs, the medicine prescription apparatus stops subsequent processes. If not, the medicine prescription apparatus returns to step S901 and proceeds to execute steps S902 through S906.

After the prescription effective term check process in FIG. 9 is executed, the medicine prescription apparatus returns to step S804 and repeats to execute steps S803 and S804 for all the records assigned to each of the prescription numbers related to the patient who requests the prescription (S802). After the process is executed for any records of every prescription number, the medicine prescription apparatus finishes the display information determination process.

After the display information determination process shown on FIG. 8 is executed, the medicine prescription apparatus returns to step S702 in FIG. 8. At step S703, as a result of the display information determination process, if it is determined that there is no prescription information to be displayed, an error as mentioned above is displayed at the error display process S708. If it is determined that there is prescription information to be displayed, the display process S704 is executed.

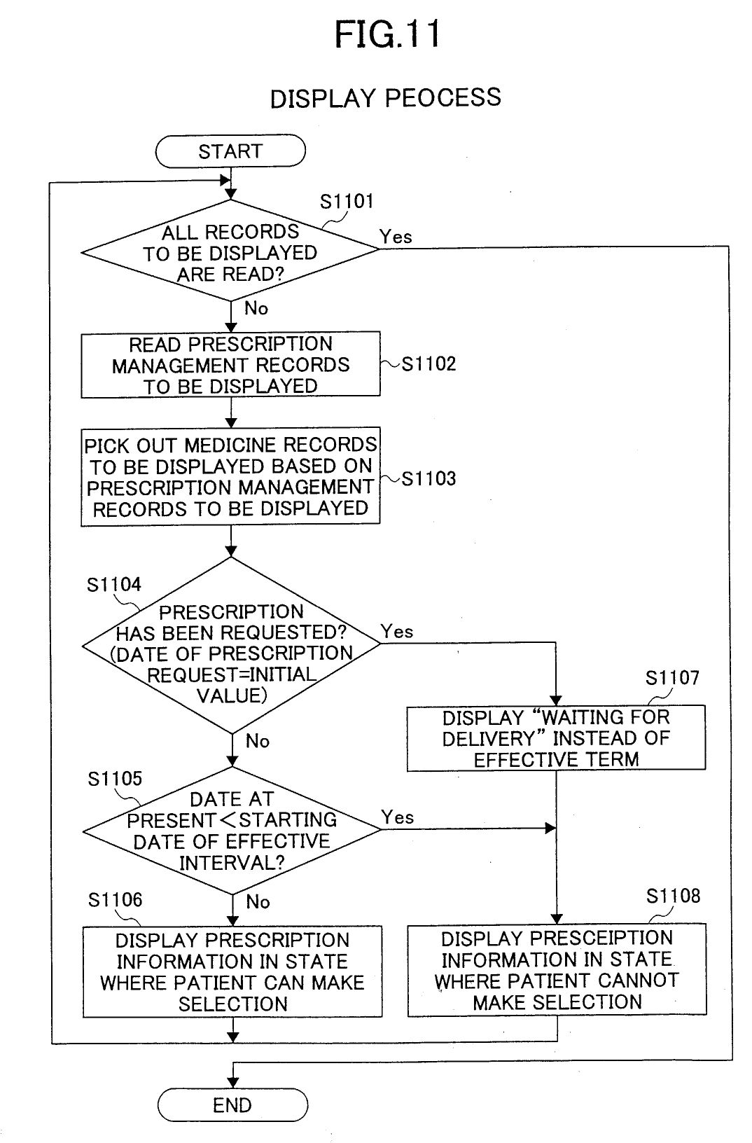

A description will be now given, with reference to a flowchart in FIG. 11, of the display process S704.

The medicine prescription apparatus reads prescription management records to be displayed that have been stored at step S906 in the prescription effective term check process shown on the above-mentioned FIG. 9 (S1102).

Then, the medicine prescription apparatus reads the corresponding medicine records from the medicine information file 302 on the basis of the patient number and the prescription numbers filled out in the read prescription management records (S1103).

In the case that the date of prescription request filled out in the prescription management records is not equal to an initial value, that is, the case that the patient has already requested the prescription, the medicine prescription apparatus puts the date of prescription request and a message such as “Waiting for Delivery” into the position where the effective term of prescription should be displayed (S1107).

Next, the medicine prescription apparatus converts the following information into the HTML form; the prescription management records read at step S1102, the medicine records picked out at step S1103, and the contents edited at step S1107. Then, the medicine prescription apparatus sends what has been converted into HTML to the patient's terminal through networks. As a result, the medicine prescription apparatus can have the information displayed on the patient's terminal in a state where the patient cannot select the prescription information (S1108).

The above-mentioned description is illustrated as the prescription information 1604 in FIG. 16.

At step S1104, in the case that the date of prescription request filled out in the prescription management record is an initial value, that is, the case that the patient has not requested the prescription yet, if the date of the starting day of the effective term of the record concerned is later than the present date, that is, the present date is not within the effective term, the medicine prescription apparatus converts into HTML form what is edited from the prescription management record read at step S1102 and the medicine record picked out from the medicine information file at step S1103, which is sent to the patient's terminal through networks. As a result, the medicine prescription apparatus can have the information displayed on the patient's terminal in a state where the patient cannot select the prescription information (S1108).

The above-mentioned description is illustrated as the prescription information 1603 in FIG. 16.

At step S1105, if the date of the starting day of the effective term filled out in the prescription management record is earlier than or equal to the present date, that is, the present date is within the effective term, the medicine prescription apparatus converts into the HTML form what is edited from the prescription management record read at step S1102 and the medicine record picked out at step S1103, which is sent to the patient's terminal through networks. As a result, the medicine prescription apparatus can have the information displayed on the patient's terminal in a state where the patient can select the prescription information (S1106).

The above-mentioned description is represented as the prescription information 1602 in FIG. 16.

When steps S1106 and S1108 are completed, the medicine prescription apparatus returns to step S1101 and repeats the above-mentioned processes until all the prescription management records to be displayed are processed.

When the display process shown in FIG. 11 is completed, the patient refers to a list of prescription information pieces shown in the screen 1601 in FIG. 16, and then selects a piece of the prescription information that the patient would like to request among pieces of prescription information available (S705 in FIG. 7).

After receiving the prescription request from the patient, the medicine prescription apparatus executes a prescription information release process S706 as shown in FIG. 7.

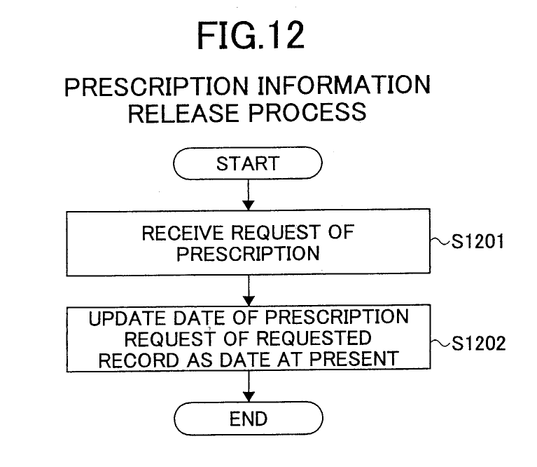

A description will be now given, with reference to a flowchart in FIG. 12, of the prescription information release process.

After receiving prescription request information from the patient (S1201), the medicine prescription apparatus refers to the prescription management file 401 and updates a date of prescription request in the prescription management record concerned to the present date (S1202).

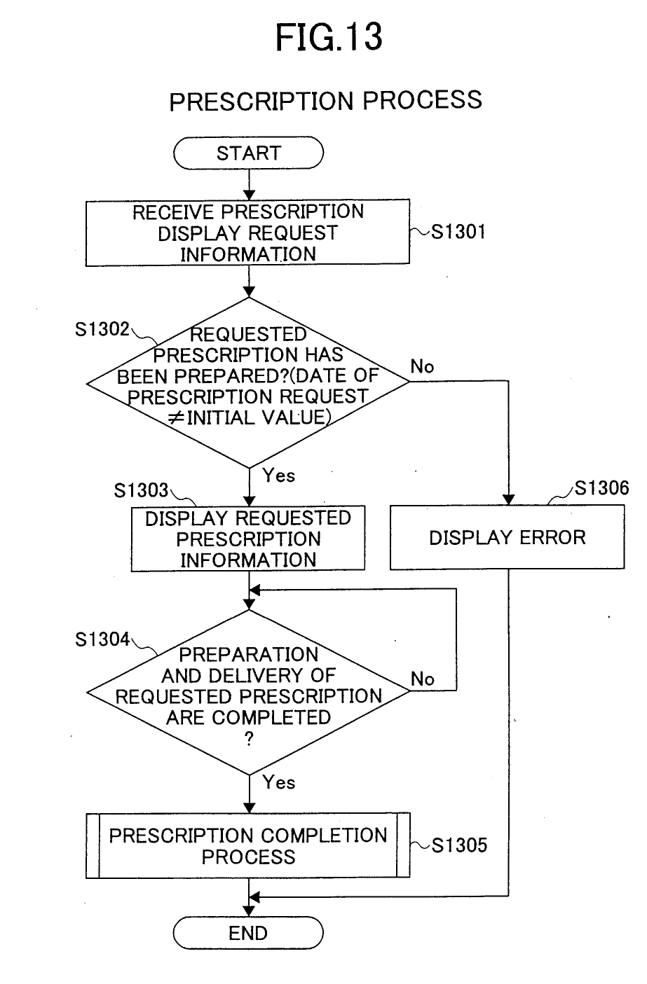

The update of the date of prescription request in the prescription management file triggers making the prescription information concerned available for release. An execution of the prescription process shown in FIG. 13 that will be mentioned later makes it possible to release prescription information to a terminal of a pharmacy.

When the prescription information release process shown in FIG. 12 is completed, the medicine prescription apparatus returns to step S706 shown in FIG. 7 and executes a prescription number notification process S707 to send the prescription number of the requested prescription information in HTML form to the patient's terminal and display the prescription number on the terminal.

Here, the medicine prescription apparatus may decide not to use the above-mentioned way to display the prescription number on the patient's terminal but adopt a way to send the prescription number to the patient's e-mail address.

When the prescription number notification process shown in FIG. 12 is completed, the medicine prescription apparatus returns to step S502 shown in FIG. 5 and determines whether or not there are some errors such as the limited time of prescriptions error (S503). If there is no error, the medicine prescription apparatus moves to the prescription process S504. If there are some errors, the medicine prescription apparatus is terminated without executing subsequent processes.

A description will be now given, with reference to a flowchart in FIG. 13, of the prescription process.

At the prescription information release process, a pharmacist connects the pharmacist's terminal with the medicine prescription apparatus through networks, inputs a patient number and a prescription number of the patient concerned, and sends prescription display request information including the patient number and the prescription number to the medicine prescription apparatus in order to refer to prescription information available.

The medicine prescription apparatus receives the above-mentioned prescription display request information (S1301).

Based on the received prescription display request information, the medicine prescription apparatus refers to the prescription management file 401 and checks whether or not a date of prescription request filled out in the record of the prescription information concerned is an initial value (S1302).

If so, that is, a prescription under the prescription information has not been requested yet, a pharmacy is not allowed to prepare the prescription. Accordingly, the medicine prescription apparatus displays an error message that the prescription request has not been processed yet on the terminal of the pharmacy through networks (S1306), and then stops subsequent processes.

If not, that is, the prescription under the prescription information has been already requested, the medicine prescription apparatus edits the record concerned in the prescription management file and the record concerned in the medicine information file, for example, in HTML form similar to a paper-based prescription which is conventionally used. The medicine prescription apparatus sends the prescription information converted into HTML form, and displays the prescription information on the pharmacist's terminal (S1303).

Based on the prescription information displayed on the screen, the pharmacist prepares the prescription and delivers medicines to the patient (S1304).

After the delivery of the medicines to the patient, the medicine prescription apparatus executes a prescription completion process S1305 on the basis of prescription completion information sent by the pharmacist from the pharmacist's terminal.

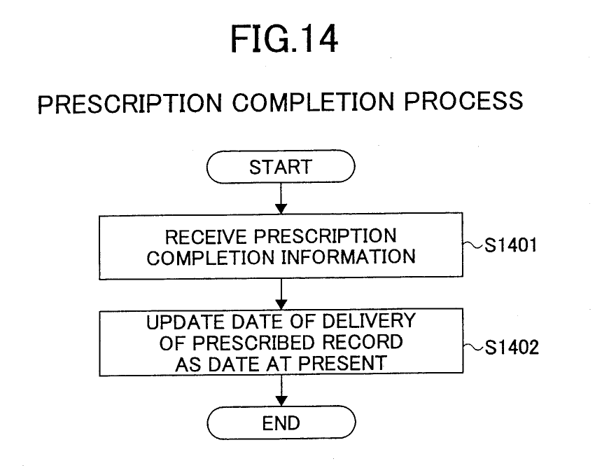

A description will be now given, with reference to a flowchart in FIG. 14, of the prescription completion process S1305.

The medicine prescription apparatus receives the prescription completion information including the patient number and the prescription number from the pharmacist's terminal through networks (S1401).

Based on the received prescription completion information, the medicine prescription apparatus refers to the prescription management file and updates a date of delivery filled out in the record concerned as the present date (S1402).

When the date of delivery in the record is registered, the prescription under the prescription information concerned is completed.

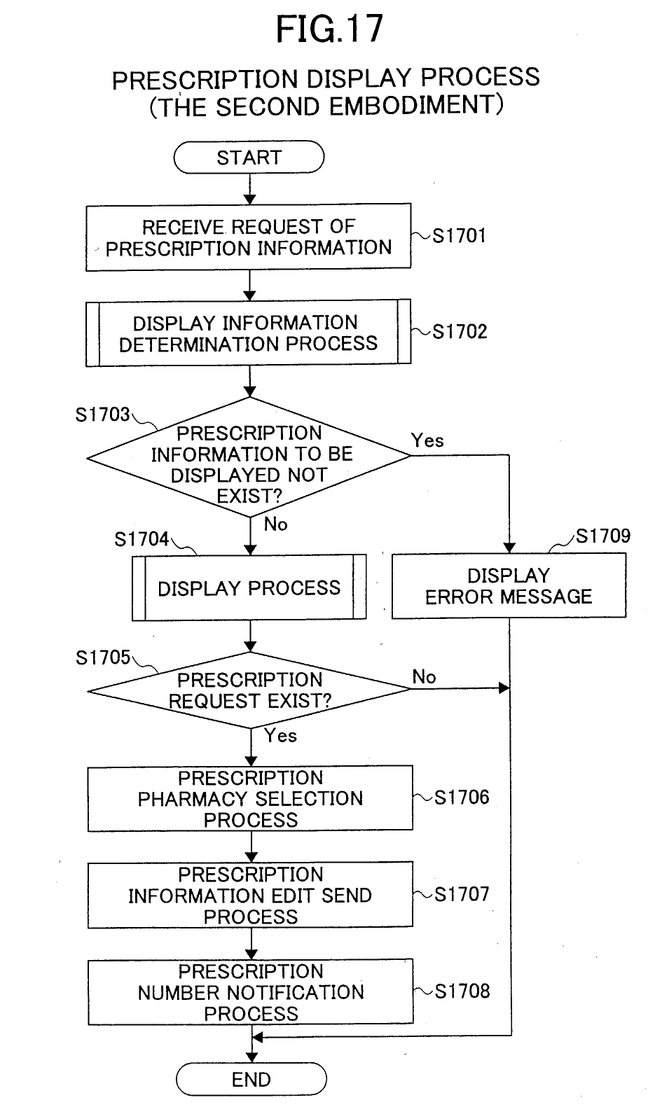

A description will now be given, with reference to FIG. 17, of a second embodiment of the present invention.

Under the above-mentioned first embodiment of the present invention, whatever pharmacy a patient visits, the patient can receive prescribed medicines at the pharmacy by showing both a prescription number assigned to a prescription that the patient would like to request and the patient's identification as long as the pharmacy is registered in the pharmacy file maintained by the medicine prescription apparatus.

Under the first embodiment of the present invention, the patient, however, has to wait for preparation of the prescription, because a pharmacist in the pharmacy does not begin the preparation until the patient comes to the pharmacy.

In the second embodiment of the present invention, the patient is allowed to designate a pharmacy that the patient hopes that will prepare a prescription and deliver prescribed medicines to the patient. Furthermore, as soon as the patient requests the prescription, the corresponding prescription information is sent to the designated pharmacy. As a result, it takes less time for the patient to wait for receiving prescribed medicines.

In the prescription display process shown in FIG. 17, after a prescription is requested (S1705), a prescription pharmacy selection process S1706 and a prescription information edit sending process S1707 are executed.

Except the above-mentioned steps, the prescription display process shown in FIG. 17 is equivalent to the prescription display process of the first embodiment of the present invention shown in FIG. 7.

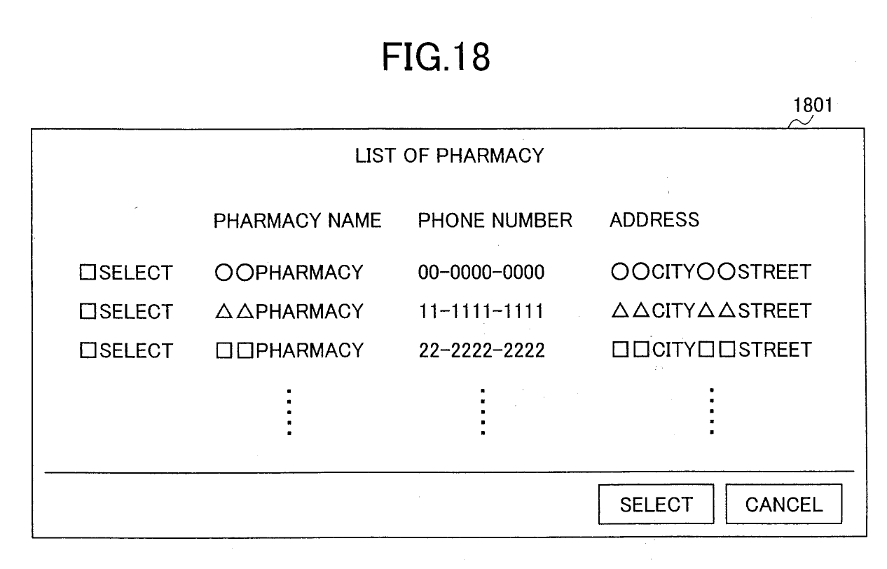

At the prescription pharmacy selection process S1706, the patient requests a prescription from the list of pieces of prescription information displayed on prescription display screen as shown in FIG. 16. Then, the medicine prescription apparatus displays a prescription pharmacy selection screen as shown in FIG. 18.

The prescription pharmacy selection screen in FIG. 18 is displayed on the patient's terminal by sending to the patient's terminal information on pharmacies that is read from the pharmacy file 302 and then is converted into HTML form.

Among the displayed pharmacies available for preparing the prescription, the patient selects a pharmacy that the patient would like to visit.

Here, although not illustrated in FIG. 18, the prescription pharmacy selection screen may be modified so that the patient can also designate a date of the day when the patient would like to receive medicines.

After the prescription pharmacy selection process S1706 is executed, the medicine prescription apparatus edits the prescription information requested at step S1705, for example, in a paper-based prescription form which is conventionally used, and then sends the edited prescription information to an e-mail address of the pharmacy selected at step S1706 through networks. (S1707).

The pharmacy can prepare the prescription in advance, because the prescription information is sent as soon as the prescription is requested.

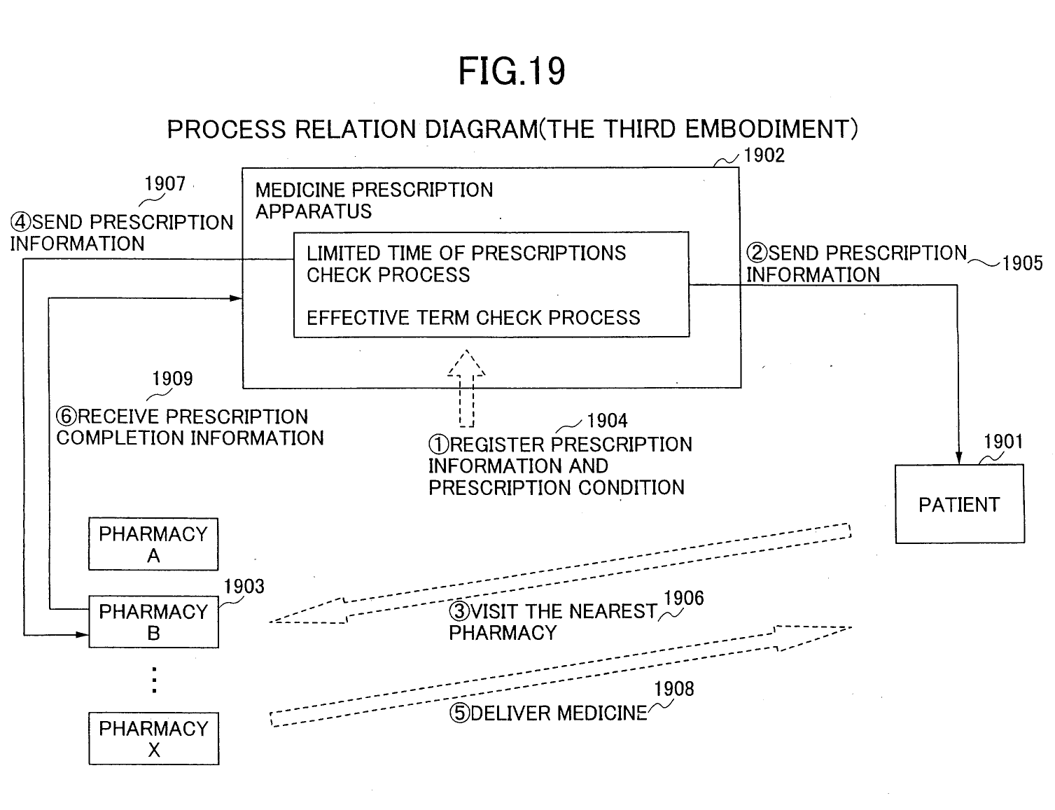

A description will now be given, with reference to FIG. 19, of a third embodiment of the present invention.

The first and the second embodiments as mentioned above are embodiments wherein according to a prescription request of a patient, a pharmacy receives prescription information, and the pharmacy prepares the prescription under the prescription information. However, in the third embodiment of the present invention, a description will be given, of a prescription apparatus capable of prescribing medicines without the patient's prescription request.

At the beginning, a doctor inputs prescription information for a patient 1901 and the corresponding prescription condition from the doctor's terminal in the same way as the first and the second embodiments (1904).

When the remainder of previously prescribed medicines decreases, the patient 1901 has access from the patient's terminal to a medicine prescription apparatus 1902 in order to gain a prescription of the same medicines as the previously prescribed medicines. Then, a medicine prescription apparatus 1902 sends the prescription information on the patient 1902 to the patient's terminal (1905).

Regarding the above-mentioned prescription information, the medicine prescription apparatus 1902 executes the effective term check process and the limited times of prescriptions check process as explained in the first and the second embodiments, and sends to the patient's terminal only prescription information satisfying the prescription condition provided by the doctor.

The patient 1901 confirms the content of the displayed prescription information, and additionally confirms the availability of medicines that the patient hopes that will be prescribed.

If the medicines are allowed to be prescribed, the patient 1901 visits the nearest pharmacy 1903 and shows identification such as a consultation card of the patient and a prescription number displayed at the time when the patient confirms the availability of the prescription. (1906).

Here, the patient 1901 may directly visit the pharmacy without the confirmation with regard to the availability in advance.

After a pharmacist is presented the prescription number together with the identification, the pharmacist inputs a patient number assigned to the patient from the pharmacist's terminal and receives prescription information from the medicine prescription apparatus 1902 (1907).

The pharmacist confirms the received prescription information, checks the availability of the prescription that the patients hope that will be prepared and delivers prescribed medicines to the patient (1908).

After the delivery of the medicine to the patient 1901 is completed, the pharmacist sends prescription completion information from the pharmacist's terminal to the medicine prescription apparatus (1909).

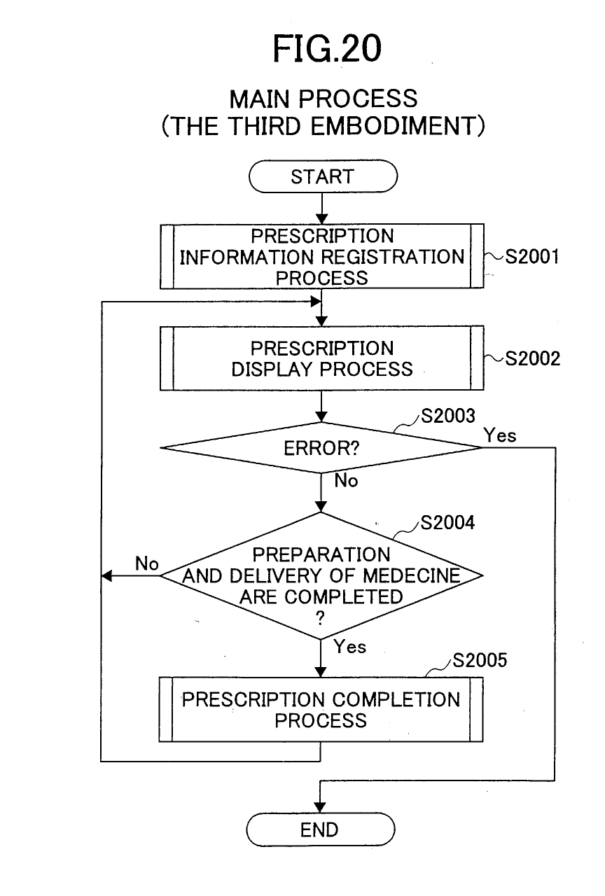

A description will be now given, with reference to a flowchart in FIG. 20, of a main process of the third embodiment of the present invention.

Similarly to the first and the second embodiments of the present invention, a doctor in a medical institution performs a prescription information registration process S2001 to register prescription information for a patient of the doctor's and a prescription condition thereof.

Next, the patient performs a prescription display process S2002 to confirm whether or not medicines are allowed to be prescribed at present.

As mentioned above, the patient is not required to confirm the availability of the prescription.

When the patient visits a pharmacy to receive the prescribed medicine, a pharmacist in the pharmacy performs a prescription display process S2002 to confirm prescription information on the patient.

When the prescription display process S2002 is completed, it is determined whether or not there is an error (S2003). If so, the medicine prescription apparatus stops without executing subsequent steps. If not, the medicine prescription apparatus moves to the next step.

The pharmacist confirms the prescription information displayed at step S2002 and prepares the prescription. If prescribed medicines are delivered, a prescription completion process S2005 is executed. If the pharmacist cannot prepare the prescription because the prescription information is out of its effective term, the medicine prescription apparatus moves back to step S2002 (S2004).

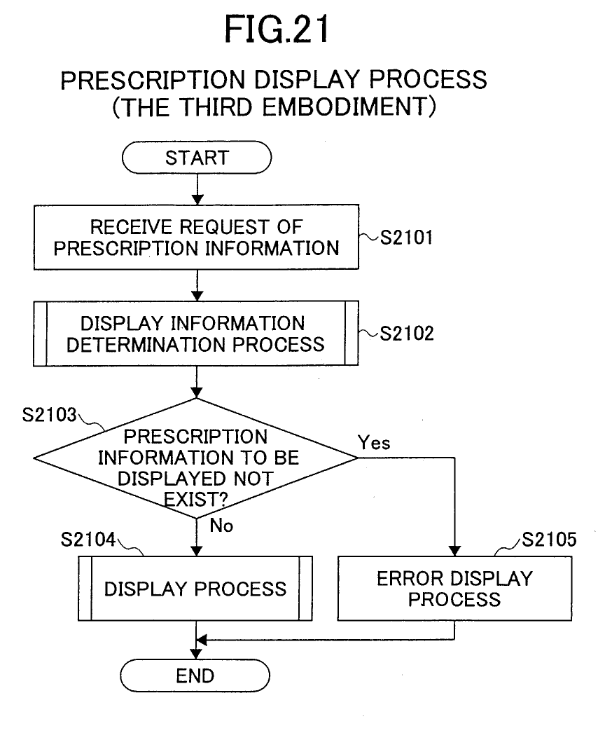

A description will now be given, with reference to a flowchart in FIG. 21, of the prescription display process.

The medicine prescription apparatus receives a display request of a patient from a terminal of the patient or a terminal of the pharmacy (S2101). Then, the medicine prescription apparatus executes a display information determination process S2102 to check whether or not there is prescription information to be displayed for the display request.

Here, the display information determination process S2102 is equivalent to that as mentioned in the first and the second embodiments. The display information determination process S2102 is also equivalent to that as mentioned in the first and the second embodiments with respect to an effective term check process and a limited time of prescriptions check process executed in the display information determination process S2102.

Based on the result of the display information determination process S2102, it is determined whether or not there is prescription information to be displayed (S2103). If not, an error display process is executed at step S2105. If so, a display process is executed at step S2104.

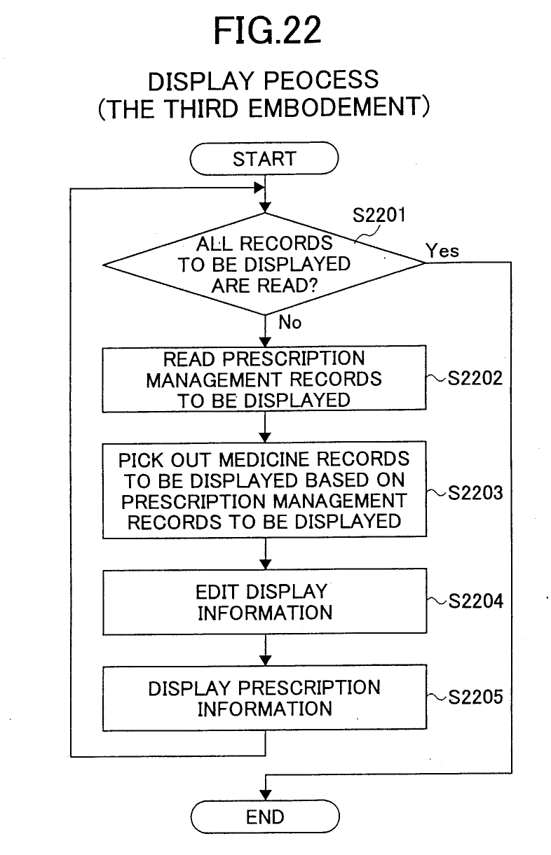

A description will be given, with reference to a flowchart in FIG. 22, of the display process.

The medicine prescription apparatus reads a record related to the prescription information to be displayed from the prescription management file that has been stored at the prescription effective term check process (S2202).

Based on a patient number and a prescription number of the read prescription management record, the medicine prescription apparatus picks out the corresponding record from the medicine information file 302 (S2203).

Based on the prescription management record that has been read at step S2202 and the medicine record that has been picked out at step S2203, the medicine prescription apparatus edits the prescription information, which is converted into HTML form (S2204). Then, the medicine prescription apparatus sends and displays the prescription information converted into HTML form to the patient's terminal or the pharmacist's terminal (S2205).

When the prescription information is edited at step S2204, the medicine prescription apparatus determines which terminal requests the display, the patient's or the pharmacist's. Depending on the result, the medicine prescription apparatus may change the edited content of the prescription information. For example, if the display request is given from a terminal of the pharmacy, the medicine prescription apparatus may edit the content of the prescription in an image similar to a paper-based prescription that is conventionally used.

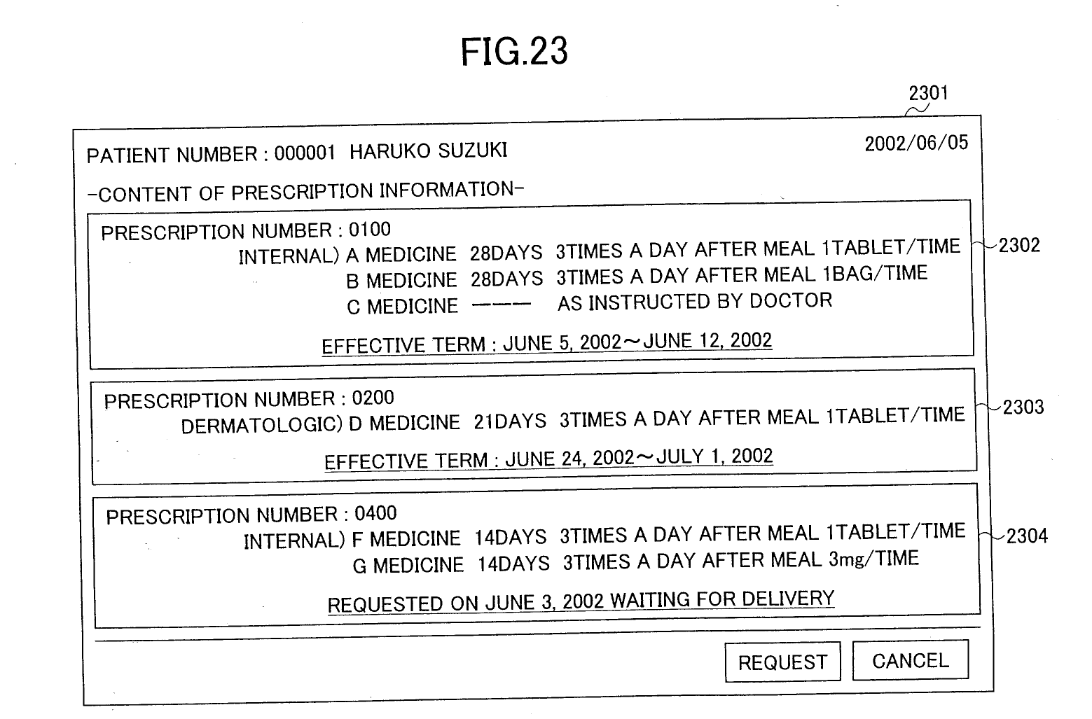

A description will be given, with reference to an example of a prescription screen display in FIG. 23, of prescription information displayed on the patient's terminal or the pharmacist's terminal.

An execution of the prescription display process displays a list of pieces of prescription information shown in FIG. 23.

In a left area of each piece of the prescription information 2302, 2303 and 2304, a prescription number to identify an individual piece of the prescription information is displayed.

With reference to the screen, the patient or the pharmacist confirms the availability of the prescription information at present.

Here, the medicine prescription apparatus displays only prescription information resulting from the display information determination process. Accordingly, the medicine prescription apparatus also displays prescription information such that a starting date of an effective term of prescription information does not come yet. For easy recognition, for example, the medicine prescription apparatus may display only prescription numbers assigned to prescription information available at present. Also, the medicine prescription apparatus may emphasize the prescription information concerned by displaying in a different color or by giving the notice “Available for Prescription”.

As mentioned above, in the case that the prescription information is displayed on the pharmacist's terminal, the medicine prescription apparatus may display not the list of pieces of prescription information shown in FIG. 23 but prescription information in the paper-based prescription form.

In the above-mentioned way, the pharmacist prepares a prescription on the basis of the displayed prescription information and delivers prescribed medicines to the patient.

After the delivery of the prescribed medicines to the patient, the pharmacist executes a prescription completion process.

The prescription completion process is equivalent to those of the first and the second embodiments.

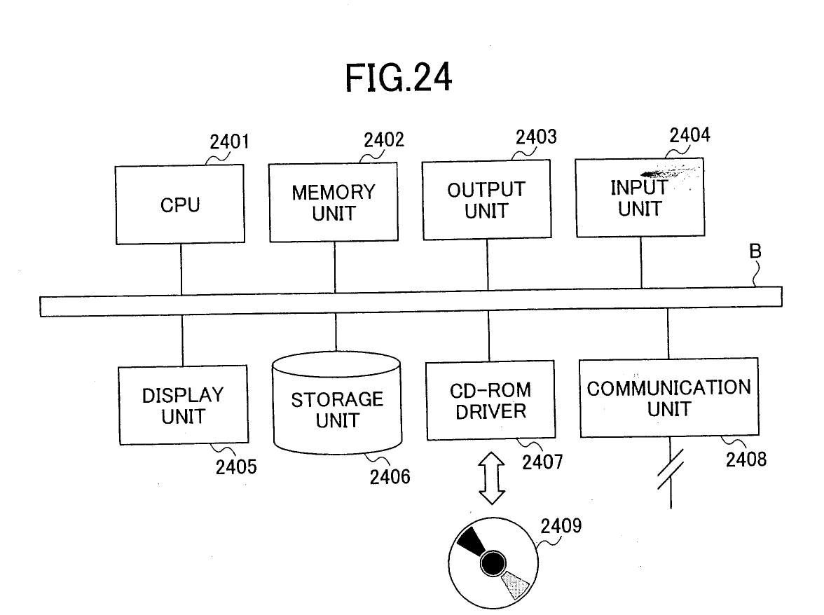

A description will be given, with reference to a block diagram in FIG. 24, of a hardware configuration in an example of the medicine prescription apparatus of the present invention.

In FIG. 24, the medicine prescription apparatus in the example includes a CPU (Central Processing Unit) 2401, a memory unit 2402, an output unit 2403, an input unit 2404, a display unit 2405, a storage unit 2406, a CD-ROM driver 2407, and a communication unit 2408, all of which are connected together through a bus B.

The CPU 2401 performs functions as the medicine prescription apparatus according to the present invention described above in accordance with programs stored in the memory unit 12 in FIG. 1. The memory unit 2402 includes a RAM and a ROM and stores the programs to be executed by the CPU 2401, data necessary for the processes and data obtained by the processes. Also, a part of an area of the memory unit 2402 is used as a working area for the processes executed by the CPU 2401.

The communication unit 2408 controls data transmissions for sending or receiving information between the medicine prescription apparatus and terminals of patients or terminals of medical institutions.

The input unit 2404 includes a mouse, a keyboard or the like and is used to input information. The storage unit 2406 includes a hard disk and stores the patient file 110, the prescription condition table 111, the prescription management file 112, the medicine information file 113, the pharmacy file 114, the patient registration program 103, the prescription information registration program 104, the prescription condition program 105, the display information determination program 106, the prescription information release program 107, the prescription display program 108, the prescription completion program 109 and the HTML editor 102.

In the case that the medicine prescription apparatus is distributed for sale, it is possible that the program to execute functions of the medicine prescription apparatus may be distributed in a state where the program is stored in a movable type media such as a CD-ROM (Compact Disk Read Only Memory) or a floppy disk, or may be transferred to other computers through networks.

For example, programs of the processes are installed into the medicine prescription apparatus by loading a CD-ROM 2409 into the CD-ROM driver 2407. When the CD-ROM 2409 storing the programs is inserted in the CD-ROM driver 2407, the CD-ROM driver 2407 reads the programs from the CD-ROM 2409 and the programs read from the CD-ROM 2409 is installed into the storage unit 2406 via the bus B. When the processes are executed, the CPU 2401 executes the processes in accordance with the programs installed into the storage unit 2406.

It should be noted that a recording medium is not limited to the CD-ROM 2409, but another computer-readable recording medium such as a magnetic disk, a magnetic tape, an optical disk, a magneto-optical disk, a semiconductor memory or the like may be used.

The present invention is not limited to the specifically disclosed embodiments, and variations and modifications may be made without departing from the scope of the present invention.

The present application is based on Japanese priority application No. 2002-182337 filed Jun. 24, 2002, the entire contents of which are hereby incorporated by reference.

What is claimed is:

1. A medicine prescription apparatus, comprising:
a registration part registering prescription information on a patient and a prescription condition on said prescription information including an effective term of said prescription information;
a receiving part receiving said patient's request to acquire said prescription information from a predetermined terminal;
a determination part checking whether or not the present date is within said effective term of said prescription information; and
a sending part sending said prescription information to said predetermined terminal if said determination part determines that the present date is within said effective term of said prescription information.

2. The medicine prescription apparatus as claimed in claim 1, wherein;
said registration part registers said prescription information and said prescription condition given by a doctor in charge of said patient from a terminal of said doctor;
said determination part determines which pieces of said prescription information are currently valid for said patient according to said prescription information and said prescription condition including said effective term, in response to said request to acquire said prescription information from said predetermined terminal; and
said sending part sends said prescription information together with current validity for said patient to said predetermined terminal, whereby said patient can determine whether to ask a pharmacy to prepare a prescription according to said prescription information.

3. The medicine prescription apparatus as claimed in claim 1, wherein;
said registration part registers a limited time of prescriptions set by a doctor, meaning the number of times that said prescriptions under said prescription information are allowed to be prepared; and
said determination part checks whether or not the number of times when said prescriptions under said prescription information have ever been delivered to said patient reaches said limited time of prescriptions.

4. The medicine prescription apparatus as claimed in claim 1, wherein:
said registration part registers a prescription interval set by a doctor, meaning an interval within which said prescription under said prescription information is allowed to be prepared; and
said effective term is computed on the basis of a day when an immediately previous prescription under said prescription information has been prepared and said prescription interval.

5. The medicine prescription apparatus as claimed in claim 1, wherein:
said sending part sends said prescription information whose starting date of said effective term is on and after the present date together with said effective term.

6. The medicine prescription apparatus as claimed in claim 1, wherein;
said receiving part receives from a terminal of a pharmacy prescription completion information, meaning that said patient has just received prescribed medicines; and then said prescription information and said prescription condition are updated on the basis of said prescription completion information.

7. The medicine prescription apparatus as claimed in claim 1, wherein;
said receiving part receives from said patient's terminal a request for a prescription under said prescription information that said sending part has already sent to said patient's terminal; and
said sending part releases said prescription information to a pharmacy that said patient is asking to prepare said prescription under said prescription information.

8. The medicine prescription apparatus as claimed in claim 1, wherein;
said receiving part receives from said patient's terminal a request for said prescription under said prescription information that said sending part has already sent to the patient's terminal and information on a pharmacy that said patient would like to prepare said prescription under said prescription information; and
said sending part releases said prescription information to said pharmacy.

9. A method of prescription of a medicine prescription apparatus, comprising:
a registration step registering prescription information on a patient and a prescription condition on said prescription information including an effective term of said prescription information;
a receiving step receiving said patient's request to acquire said prescription information from a predetermined terminal;
a determination step checking whether or not the present date is within said effective term of said prescription information; and
a sending part sending said prescription information to said predetermined terminal if said determination step determines that the present date is within the effective term of said prescription information.

10. The method of prescription of a medicine prescription apparatus as claimed in claim 9, further comprising the steps of:
selecting a pharmacy in advance that said patient would like to prepare a prescription under said prescription information; and
sending said prescription information to said pharmacy as soon as said patient's request for said prescription under said prescription information and information on said pharmacy selected by said patient are received.

11. A medicine prescription program for making a computer execute:
a registration step registering prescription information on a patient and a prescription condition on said prescription information including an effective term of said prescription information;
a receiving step receiving said patient's request to acquire said prescription information from a predetermined terminal;
a determination step checking whether or not the present date is within said effective term of said prescription information; and
a sending step sending said prescription information to said predetermined terminal if said determination step determines that the present date is within the effective term of said prescription information.

12. The medicine prescription program as claimed in claim 11, further for making a computer execute the steps of:
selecting a pharmacy in advance that said patient would like to prepare a prescription under said prescription information; and
sending said prescription information to said pharmacy as soon as said patient's request for said prescription under said prescription information and information on said pharmacy selected by said patient are received.

13. A computer readable medium storing a medicine prescription program for making a computer execute:
a registration step registering prescription information on a patient and a prescription condition on said prescription information including an effective term of said prescription information;
a receiving step receiving said patient's request to acquire said prescription information from a predetermined terminal;
a determination step checking whether or not the present date is within said effective term of said prescription information; and
a sending step sending said prescription information to said predetermined terminal if said determination step determines that the present date is within the effective term of said prescription information.

14. The computer readable medium as claimed in claim 13, further storing programs for making a computer execute the steps of:
selecting a pharmacy in advance that said patient would like to prepare a prescription under said prescription information; and
sending said prescription information to said pharmacy as soon as said patient's request for said prescription under said prescription information and information on said pharmacy selected by said patient are received.
